(19) United States
(12) Patent Application Publication
(10) Pub. No.: US 2025/0289442 A1
(43) Pub. Date: Sep. 18, 2025

(54) DRIVING CONTROL APPARATUS

(71) Applicant: HONDA MOTOR CO., LTD., Tokyo (JP)

(72) Inventors: Kenichi SHIRAKI, Wako-shi (JP); Takashi YANAGI, Tokyo (JP)

(21) Appl. No.: 19/062,696

(22) Filed: Feb. 25, 2025

(30) Foreign Application Priority Data
Mar. 14, 2024 (JP) 2024-040322

(51) Int. Cl. B60W 40/12; B60W 50/10

(52) U.S. Cl. CPC B60W 40/12; B60W 50/10; B60W 2520/10; B60W 2540/10

(57) ABSTRACT

A driving control apparatus includes an operation amount signal detection part, an advance angle compensation part, and a phase delay controller. The operation amount signal detection part detects an operation amount signal that is outputted from an operation member when a driver operates the operation member. The advance angle compensation part calculates advance angle compensation that compensates for a phase delay in an operation frequency band. The operation frequency band indicates a range of operation speed at which the driver operates the operation member. The phase delay controller calculates a phase delay characteristic that maintains a phase of delay of the operation amount signal at a constant level. The driving control apparatus applies the advance angle compensation and the phase delay characteristic to the operation amount signal, and transmit a resulting signal as a control amount signal for controlling an operation target.

### CROSS-REFERENCE STATEMENT

The present application is based on, and claims priority from, Japanese Patent Application Number 2024-040322, filed Mar. 14, 2024, the disclosure of which is hereby incorporated by reference herein in its entirety.

### BACKGROUND

### Technical Field

The disclosure relates to a driving control apparatus for a movable body such as a vehicle that is driven by a driver.

### Related Art

A technique has been proposed for improving a response of a device, such as an internal combustion engine, that takes some time to accelerate a vehicle from when an acceleration operation has been conducted (see Japanese Unexamined Patent Application Publication Number 2008-002330, hereinafter “JP2008-002330A”).

Meanwhile, an electric motor has a faster response compared to an internal combustion engine or the like. With an electric motor, acceleration of the vehicle starts earlier than imagined by a driver of the vehicle, leading to a case where the driver has to correct an acceleration operation.

If the correction operation is repeated, operability and driving feel deteriorates.

### SUMMARY

An aspect of the disclosure provides a driving control apparatus that includes a hardware processor. The hardware processor is configured to detect an operation amount signal that is outputted from an operation member when a driver operates the operation member, calculate advance angle compensation that compensates for a phase delay in an operation frequency band, the operation frequency band indicating a range of operation speed at which the driver operates the operation member, and calculate a phase delay characteristic that maintains a phase delay of the operation amount signal at a constant level. The hardware processor is configured to apply the advance angle compensation and the phase delay characteristic to the operation amount signal, and transmit a resulting signal as a control amount signal for controlling an operation target.

### BRIEF DESCRIPTION OF DRAWINGS

FIG. 1 is a block diagram showing a driving control apparatus of a present embodiment.

FIG. 2 is a graph showing a characteristic of a phase delay in an operation frequency band of the present embodiment.

FIG. 3 is a graph showing a characteristic of a phase delay (time) in the operation frequency band of the present embodiment.

FIG. 4 is a graph showing a characteristic of a phase delay (time, logarithmic expression) in the operation frequency band of the present embodiment.

FIG. 5 is a flowchart showing a control procedure of the present embodiment.

FIG. 6 is a graph of characteristics in accordance with the flowchart of FIG. 5.

FIG. 7 is a graph showing a characteristic of a phase delay in an operation frequency band of a modification.

### DETAILED DESCRIPTION

In the following detailed description, for purposes of explanation, numerous specific details are set forth in order to provide a thorough understanding of the disclosed embodiment. It will be apparent, however, that one or more embodiments may be practiced without these specific details. In other instances, well-known structures and devices are schematically shown in order to simplify the drawing.

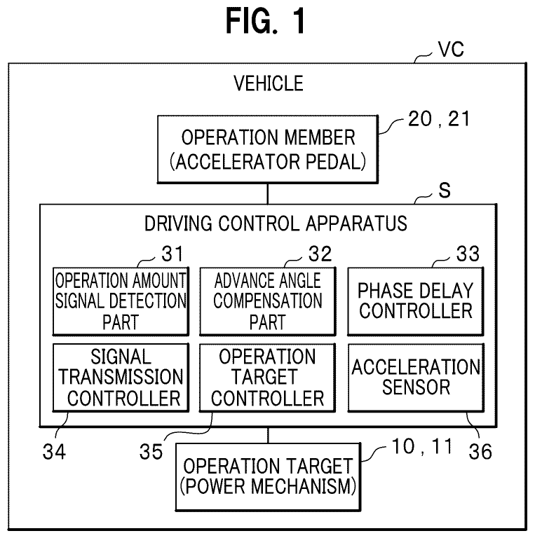

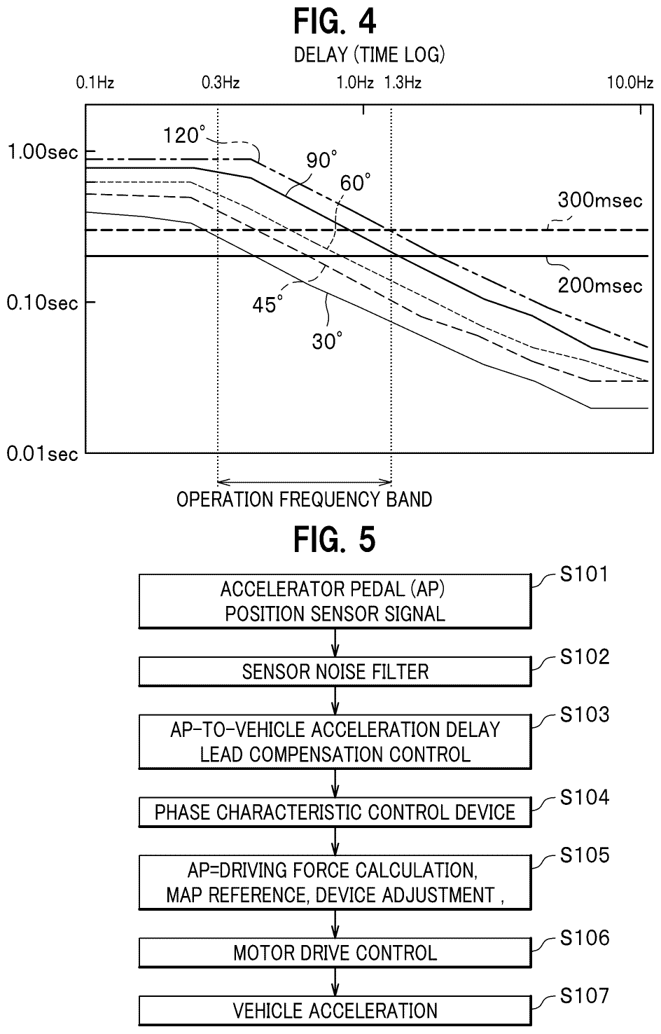

A driving control apparatus S according to an embodiment of the disclosure will be described in detail with reference to FIG. 1 to FIG. 6.

Note that in the description, the same elements are denoted by the same reference signs, and repetitive description may be omitted.

In the following description, “front” and “rear” refer respectively to “front” and “rear” in a front direction and rear direction of a vehicle (along a longitudinal axis) unless otherwise specified. Further, “right” and “left” refer respectively to “right” and “left” in a right direction and left direction of the vehicle (along a lateral axis) unless otherwise specified. Further, “up” and “down” refer to “up” an “down” in an upward direction and downward direction of the vehicle (along a vertical axis) unless otherwise specified.

The driving control apparatus S of the present embodiment controls delay in a configuration of a so-called by-wire that is included in a movable body such as a vehicle VC and operates upon transmission of operation by a driver to an operation target 10 as an electric signal (see FIG. 1).

Note that a delay refers to time taken from when a driver starts operating an operation member 20 to when the operation target 10 starts operation to change acceleration.

The operation target 10 may be a power mechanism 11 such as an engine or a motor, a steering mechanism (not shown) that adjusts a steering angle, or the like.

The operation member 20 of the power mechanism 11 is an accelerator pedal 21. The operation member 20 of the steering mechanism is a steering wheel (not shown).

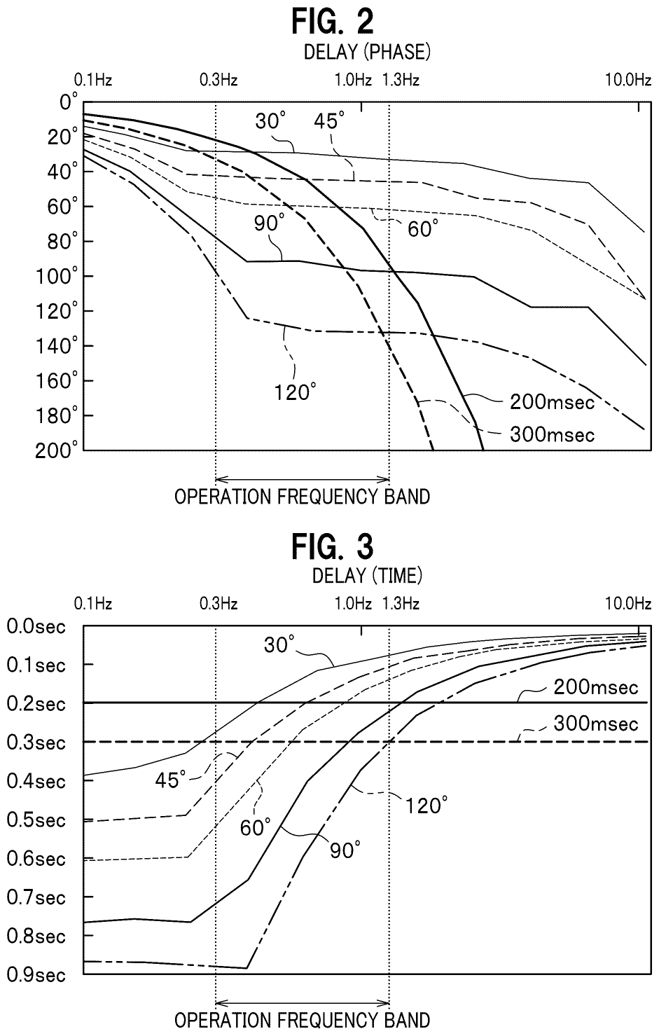

That is, a delay in the power mechanism 11 is time taken from when the accelerator pedal 21 is operated to when the power mechanism 11 is activated and acceleration of the vehicle VC in a traveling direction is changed (see FIG. 2 to FIG. 4).

A delay in the steering mechanism is time taken from when the steering wheel is operated to when the steering mechanism is activated and acceleration of the vehicle VC in a left or right direction is changed.

In the present embodiment, a speed (an operation speed) at which the operation member 20 is operated is expressed by a frequency.

That is, the faster the operation speed is, the higher the frequency becomes, and the slower the operation speed is, the lower the frequency becomes.

It has been confirmed from experiments using an actual vehicle or the like that, when a human drives the vehicle VC, the operation speeds of the accelerator pedal 21 and the steering wheel fall approximately within a range of 0.3 Hz to 1.3 Hz.

Note that hereinafter, a range of operation speed at which the driver operates the operation member 20 is referred to as an operation frequency band.

That is, the operation speed at which the driver operates the operation target 10 under various conditions falls within the operation frequency band.

Further, it has been confirmed from experiments and the like that the magnitude of delay generated at the time of operation is fixed for each operation target 10, does not change with the operation speed, and is substantially constant.

Various studies have been revealing that, for an operation target 10 having such a characteristic, the magnitude of delay that a human who is the driver imagines varies depending on the operation speed.

That is, humans have an image that, when the operation speed is fast, the operation target 10 reacts immediately without delay, while, when the operation speed is slow, the operation target 10 reacts with more delay.

For this reason, a difference arises between the

operation image of the driver and the reaction and motion of the actual vehicle, causing the driver to experience a strange feel and be forced to conduct correction operation.

In view of this, the driving control apparatus S of the present embodiment conducts control of delay in conformity with the operation image of the driver and thus improves an operating feel and enhances operability.

The driving control apparatus S of the present embodiment controls delay from an operation to a response. The driving control apparatus S of the present embodiment does not act on an operation amount or an operation speed applied by the driver.

The driving control apparatus S of the present embodiment may be configured to include a microcomputer (not shown) that includes a central processing unit (CPU), memory such as read-only memory (ROM) and random-access memory (RAM), and an input/output interface. This microcomputer may operate by reading out and executing a program and data stored in the memory and control various functions of the driving control apparatus S.

The driving control apparatus S of the present embodiment includes an operation amount signal detection part 31, an advance angle compensation part 32, a phase delay controller 33, a signal transmission controller 34, an operation target controller 35, and an acceleration sensor 36 (see FIG. 1).

The operation amount signal detection part 31 detects an operation amount signal outputted from the operation member 20 when the driver operates the operation member 20.

Note that the operation amount signal is an operation amount by which the driver has operated the operation member 20, and is an electric signal outputted from the operation member 20.

Then, the operation amount signal detection part 31 calculates an operation speed from the operation amount signal that has been detected.

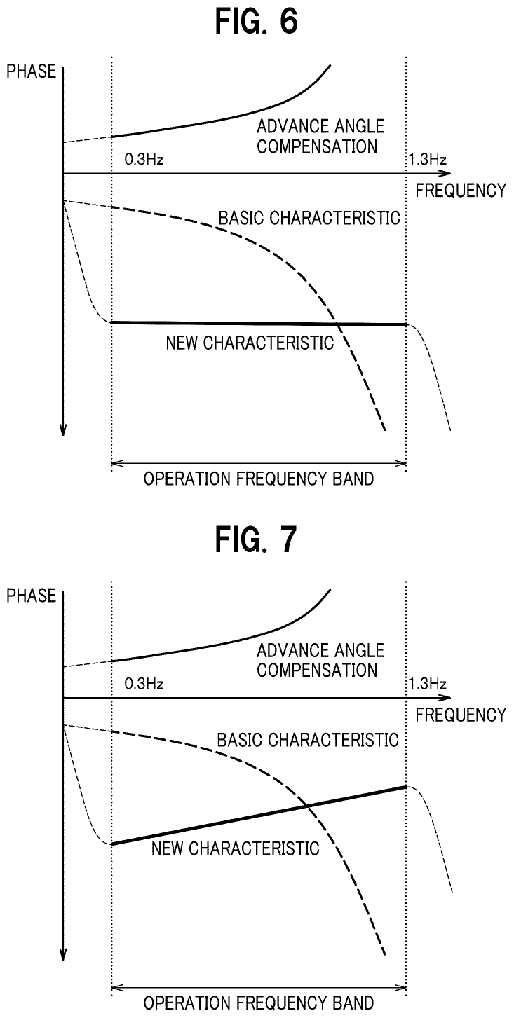

The advance angle compensation part 32 calculates an advance angle compensation from a phase delay (a phase shift that results in a delay) of the acceleration and compensates for the phase delay in the operation frequency band (see FIG. 6).

That is, the advance angle compensation part 32 calculates a phase such that the calculated phase and a phase delay from the operation amount signal to the control amount signal (a phase delay of the control amount signal with respect to the operation amount signal) are symmetrical about the phase 0°, and processes the phase delay such that the phase delay becomes smaller with an intention of eliminating the phase delay.

Note that the control amount signal is an electric signal to be inputted into the operation target 10. The operation target 10 is activated and controlled by the control amount signal.

Hence, in the conventional approach in which a delay time (delay) from when the operation member 20 is operated to when the operation target 10 responds is not controlled, the operation amount signal becomes the control amount signal as it is.

In contrast, in the case of the control amount signal of the present embodiment, the advance angle compensation and a phase delay characteristic are applied to the operation amount signal but the operation amount such as an accelerator pedal position is unchanged, and the signal is transmitted to the operation target controller 35.

The phase delay controller 33 converts a basic characteristic formula into a converted characteristic formula, and outputs a delay that is calculated with the converted characteristic formula and in accordance with the operation speed.

The basic characteristic formula is an approximate formula obtained from an actual delay time (a raw delay time) for each operation speed in an actual vehicle.

The converted characteristic formula is a mathematical formula expressing a phase delay characteristic newly set for each operation speed. The converted characteristic formula is a fractional integral of the basic characteristic formula.

An order of the fractional integral is set to satisfy the following conditions.
The delay after the conversion on a high-frequency side (near 1.3 Hz) becomes smallest in an operation frequency band (approximately 0.3 to 1.3 Hz).

That is, since the delay after the conversion may not be made shorter than the delay of the basic characteristic formula (the delay of an actual vehicle), the order of the fractional integral is set such that the delay in the case where the operation speed is fastest becomes equivalent to (coincides with) the delay of the basic characteristic formula.
The delay after the conversion on a low-frequency side (near 0.3 Hz) in the operation frequency band becomes a delay that is longest (slowest) relative to the basic characteristic formula and matches the operation feel of the driver.
The delay linearly changes across the operation frequency band.

That is, since the delay linearly increases or decreases relative to the operation speed, the delay may be made to match an image of delay of the driver.

In the present embodiment, the order is set to 1 (phase of 90°) to satisfy these conditions (see FIG. 2 to FIG. 4).

Moreover, the phase delay controller 33 maintains the phase constantly at 90° in the operation frequency band.

Note that in FIG. 2 to FIG. 4, lines of 200 msec and 300 msec are lines representing the basic characteristic formula, and the lines indicate that the delay (time) is constant irrespective of the operation speed.

In addition, lines of 30°, 45°, 60°, 90°, and 120° are lines representing the converted characteristic formula, and indicate that the delay linearly changes in each phase.

The signal transmission controller 34 adds delay to an operation signal in accordance with the delay calculated by the advance angle compensation part 32 and the phase delay controller 33, and transmits a signal thus obtained to the operation target controller 35 as a control amount signal.

The operation target controller 35 actually controls the operation target 10 such as the power mechanism 11 or the steering mechanism.

The acceleration sensor 36 detects changes in acceleration of the vehicle VC in a direction to the front or rear, a direction to the left or right, and an upward or downward direction.

Next, a case of controlling the drive of the drive motor (not shown) included in the power mechanism 11 of a vehicle that is referred to as a so-called electric vehicle by using the driving control apparatus S of the present embodiment will be described (see FIG. 5 and FIG. 6).

That is, the operation member 20 is an accelerator pedal (AP), the operation target 10 is a drive motor, and the delay is a time delay from when the accelerator pedal is operated to when the vehicle starts accelerating.

First, in step S101, the driver operates the accelerator pedal 21 so that an accelerator pedal position signal (an operation amount signal) is outputted from the accelerator pedal 21.

Next, in step S102, a filter is applied to the accelerator pedal position signal.

Note that the filter applied here may include a low-pass filter, a notch filter, or the like.

The low-pass filter is a filter for removing vehicle vibration and electrical and electronic noise which are overlapped outside the operation frequency band of a human operation.

The notch filter is a filter for preventing instantaneous deviation of a sensor value, which may be caused by a voltage fluctuation or a mechanism type, or the like.

Next, in step S103, the advance angle compensation part 32 conducts the advance angle compensation on the accelerator pedal position signal.

That is, a delay (compensated delay) for the operation speed is calculated from the basic characteristic formula.

Next, in step S104, the phase delay controller 33 converts the basic characteristic formula to a signal (converted characteristic formula) with which the phase of delay becomes constant or linear relative to the frequency (operation speed).

That is, a delay (converted delay) for the operation speed is calculated from the converted characteristic formula.

Then, the signal transmission controller 34 transmits, to the operation target controller 35, the accelerator pedal position signal (control amount signal) that is delayed by a delay amount obtained by subtracting the compensated delay from the converted delay.

Next, in step S105, the operation target controller 35 calculates, based on a state of the vehicle (a vehicle speed or the like), torque that is generated at wheel ends in accordance with the accelerator pedal operation signal.

Then, the operation target controller 35 obtains a value of current for generating the torque from a table, a map, or the like that is created in advance.

Next, in step S106, current is applied to the drive motor in accordance with the current value obtained by the operation target controller 35 to control the drive motor.

Then, in step S107, the vehicle VC starts accelerating so that the acceleration changes.

### Effects

Next, effects of the present embodiment will be described.

The driving control apparatus S of the present embodiment applies the advance angle compensation and the phase delay characteristic for a device to the operation amount signal in the operation frequency band.

This may enhance operability because delay control of the operation target may be conducted according to the speed of operation of the operation member by the driver and in conformity with the operation image of the driver.

In a case where the driver operates the accelerator pedal 21 with an image of a gradual acceleration, but acceleration starts earlier than expected, such a case can cause excessive speed or excessive deceleration.

Then, because a response characteristic is different from the operation image, this will cause the driver to conduct a correction operation.

Further, the driver will have to pay attention every time the driver operates the accelerator pedal 21, which will increase the burden on the driver.

In contrast, with a response characteristic that is in conformity with an imagined operation feel, it may be possible to reduce correction operations and reduce the burden on the driver.

Further, a reduction of correction operations may suppress changes to acceleration that occurs at short intervals, thereby improving ride comfort.

Moreover, a reduction of correction operations may reduce electric power consumption associated with the correction operations, leading to an enhancement in electric power efficiency and extension in cruising distance.

Further, the advance angle compensation part 32 included in the driving control apparatus S of the present embodiment calculates a phase amount such that the calculated phase amount and a phase delay from the operation amount signal to the control amount signal are symmetrical about phase 0°. Further, the advance angle compensation part 32 conducts control such that the phase delay becomes smaller with an intention of eliminating the phase delay.

This makes it possible to maintain the phase set by the phase delay controller 33, and to thus conduct more appropriate phase delay control in conformity with the operation feel of the driver.

Note that although the phase of delay is controlled to be constant at 90° by the driving control apparatus S of the present embodiment, the disclosure is not limited to such a form.

For example, it may be possible to employ the following configuration: a change in acceleration of the vehicle is measured by using the acceleration sensor 36; an operation image of the driver is learned from delay from when the operation is started to when the acceleration changes and correction operation; and the phase of delay is corrected as appropriate to be constant at 80°, constant at 100°, or the like.

Such configuration may achieve an operation that is closer to the operation image of the driver, thus further achieving the aforementioned effects.

### Modification

Next, a modification of the driving control apparatus S will be described in detail with reference to FIG. 7.

Note that in the description, the same elements as those in the aforementioned embodiment are denoted by the same reference signs, and repetitive description is omitted.

The driving control apparatus S of the present modification differs from the aforementioned embodiment in a gradient of a converted characteristic formula stored in the phase delay controller 33.

In the present modification, the converted characteristic formula is set such that a difference in delay becomes larger between a case of conducting slow operation (on the low-frequency side of the operation frequency band) and a case of conducting fast operation (on the high-frequency side of the operation frequency band).

That is, the converted characteristic formula is set such that the phase of delay linearly changes or increases or decreases between the low-frequency side and the high-frequency side.

Such a configuration makes it possible to achieve the same effects as in the aforementioned embodiment.

Further, by controlling the phase such that the phase of delay increases or decreases in proportion to the frequency within the operation frequency band, it may be possible to provide operation feels that are suitable for different driving modes and thus improve merchantability.

For example, it may be possible to achieve operation feels suitable for different driving modes such as a sports mode, in which faster response on the high-frequency side of the operation frequency band is provided to achieve exhilarating acceleration, and an economy mode, in which smooth acceleration and deceleration is provided to improve fuel efficiency or electric power efficiency.

### Aspects

A first aspect of the disclosure provides a driving control apparatus that includes an operation amount signal detection part, an advance angle compensation part, and a phase delay controller. The operation amount signal detection part is configured to detect an operation amount signal that is outputted from an operation member when a driver operates the operation member. The advance angle compensation part is configured to calculate advance angle compensation that compensates for a phase delay in an operation frequency band, the operation frequency band indicating a range of operation speed at which the driver operates the operation member. The phase delay controller configured to calculate a phase delay characteristic that maintains a phase delay of the operation amount signal at a constant level. The driving control apparatus is configured to apply the advance angle compensation and the phase delay characteristic to the operation amount signal, and transmit a resulting signal as a control amount signal for controlling an operation target.

A second aspect of the disclosure provides a driving control apparatus that includes an operation amount signal detection part, an advance angle compensation part, and a phase delay controller. The operation amount signal detection part is configured to detect an operation amount signal that is outputted from an operation member when a driver operates the operation member. The advance angle compensation part is configured to calculate advance angle compensation that compensates for a phase delay in an operation frequency band, the operation frequency band indicating a range of operation speed at which the driver operates the operation member. The phase delay controller is configured to calculate a phase delay characteristic that controls a phase of delay of the operation amount signal to linearly increase or decrease from a low-frequency side to a high-frequency side of the operation frequency band. The driving control apparatus is configured to apply the advance angle compensation and the phase delay characteristic to the operation amount signal, and transmit a resulting signal as a control amount signal for controlling an operation target.

A third aspect of the disclosure provides a driving control apparatus based on the first aspect or second aspect. According to the third aspect, the advance angle compensation part is configured to calculate a phase amount such that the calculated phase amount and a phase delay from the operation amount signal to the control amount signal are symmetrical about phase 0°, and conduct the advance angle compensation such that the phase delay is eliminated.

An object of the disclosure is to provide a driving control apparatus that is capable of improving operability by conducting delay control on an operation target in accordance with speed of operation of a driver, including an accelerator pedal operation.

The disclosure may in turn further improve safety of traffic and thus contribute to the development of sustainable transportation systems.

The disclosure makes it possible to provide a driving control apparatus that may improve operability by conducting delay control on an operation target in accordance with speed of operation of an operation member by a driver.

Then, the disclosure may in turn further improve safety of traffic and thus contribute to the development of sustainable transportation systems.

What is claimed is:

1. A driving control apparatus, comprising a hardware processor, wherein
the hardware processor is configured to:
detect an operation amount signal that is outputted from an operation member when a driver operates the operation member;
calculate advance angle compensation that compensates for a phase delay in an operation frequency band, the operation frequency band indicating a range of operation speed at which the driver operates the operation member;
calculate a phase delay characteristic that maintains a phase delay of the operation amount signal at a constant level; and
apply the advance angle compensation and the phase delay characteristic to the operation amount signal, and transmit a resulting signal as a control amount signal for controlling an operation target.

2. A driving control apparatus, comprising a hardware processor, wherein
the hardware processor is configured to:
detect an operation amount signal that is outputted from an operation member when a driver operates the operation member;
calculate advance angle compensation that compensates for a phase delay in an operation frequency band, the operation frequency band indicating a range of operation speed at which the driver operates the operation member;
calculate a phase delay characteristic that controls a phase of delay of the operation amount signal to linearly increase or decrease from a low-frequency side to a high-frequency side of the operation frequency band; and
apply the advance angle compensation and the phase delay characteristic to the operation amount signal, and transmit a resulting signal as a control amount signal for controlling an operation target.

3. The driving control apparatus according to claim 1, wherein
the hardware processor is configured to calculate a phase amount such that the calculated phase amount and a phase delay from the operation amount signal to the control amount signal are symmetrical about phase 0°, and conduct the advance angle compensation such that the phase delay is eliminated.

4. The driving control apparatus according to claim 2, wherein
the hardware processor is configured to calculate a phase amount such that the calculated phase amount and a phase delay from the operation amount signal to the control amount signal are symmetrical about phase 0°, and conduct the advance angle compensation such that the phase delay is eliminated.
